(19) United States
(12) Patent Application Publication
(10) Pub. No.: US 2010/0305228 A1
(43) Pub. Date: Dec. 2, 2010

(54) PROCESS FOR PRODUCTION OF FLEXIBLE POLYURETHANE FOAMS WITH LOW EMISSION

(75) Inventors: Matthäus Gossner, Koln (DE); Peter Haas, Haan (DE); Sven Meyer-Ahrens, Leverkusen (DE); Bert Klesczewski, Koln (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/784,913

(22) Filed: May 21, 2010

(30) Foreign Application Priority Data
May 27, 2009 (DE) 102009022817.9

(51) Int. Cl. C08J 9/00; C08G 18/06

(52) U.S. Cl. 521/126; 521/155

(57) ABSTRACT

The present invention provides a process for the production of polyurethane foams from
A1 compounds which contain hydrogen atoms which are reactive towards isocyanates and have a molecular weight of 400-15,000,
A2 optionally compounds which contain hydrogen atoms which are reactive towards isocyanates and have a molecular weight of 62-399,
A3 water and/or physical blowing agents,
A4 optionally auxiliary substances and additives, such as
   a) catalysts which differ from component A5,
   b) surface-active additives,
   c) pigments or flameproofing agents,
A5 at least one tin(II) salt of carboxylic acids, the carboxylic acid having from 10 to 16 carbon atoms, and
B di- or polyisocyanates,

wherein the resulting polyurethane foams have low emission values and a good resistance to ageing.

### RELATED APPLICATIONS

This application claims benefit to German Patent Application No. 10 2009 022 817.9, filed May 27, 2009, which is incorporated herein by reference in its entirety for all useful purposes.

### BACKGROUND OF THE INVENTION

The present invention provides a process for the production of polyurethane foams, in particular flexible polyurethane foams, wherein the resulting polyurethane foams have low emission values and a good resistance to ageing.

It is known from the prior art that polyurethane foams can emit volatile organic constituents (VOC), this emission in general being undesirable. These emissions are detected e.g. in measurements by the method according to VDA 278.

DE-A 1 121 802 and U.S. Pat. No. 3,397,158 disclose a process for the production of polyurethane foams with the aid of tin(II) salts of carboxylic acids having 1 to 18 carbon atoms, such as tin(II) octoate, tin(II) oleate, tin(II) stearate, tin(II) acetate or tin(II) (2-ethylhexoate).

A process is likewise known for the production of polyurethane foams with the aid of the tin(II) salt of ricinoleic acid, Sn(C₁₈H₃₃O₃)₂, for example Kosmos® EF from Evonik Goldschmidt GmbH, 45127 Essen, Germany.

The tin catalysts known from the prior art have a number of disadvantages in the production of polyurethane foams, such as high emission or fogging values (e.g. in accordance with VDA 278) and reduced mechanical properties after ageing.

There was a great need to provide polyurethane foams which have both a low emission and a good resistance to ageing (in particular a good level of values with respect to compression set. The object of the present invention is therefore to provide a process which allows the production of polyurethane foams, in particular flexible polyurethane foams, which have both a low emission and a good resistance to ageing (in particular a good level of values for the compression set and the values after ageing in hot air and after ageing in a steam autoclave).

### EMBODIMENTS OF THE INVENTION

An emboidment of the present invention is a process for producing a polyurethane foam from
A1 a compound comprising hydrogen atoms reactive towards isocyanate groups and having a molecular weight of from 400 to 15,000;
A2 optionally a compound comprising hydrogen atoms reactive towards isocyanate groups and having a molecular weight of from 62 to 399;
A3 water and/or a physical blowing agent;
A4 optionally at least one auxiliary substance and/or additive;
A5 at least one tin(II) salt of a carboxylic acid, wherein said carboxylic acid comprises from 10 to 16 carbon atoms; and
B a di- or polyisocyanate;
   wherein said process comprises reacting A1 and optionally A2 with B in the presence of A3, optionally A4, and A5.

Another embodiment of the present invention is the above process, wherein said at least one auxiliary substance and/or additive is a catalyst different from component A5, a surface active additive, a pigment, and/or a flameproofing agent.

Another embodiment of the present invention is the above process, wherein
A1 is used in an amount of from 75 to 99.5 parts by weight based on the sum of the parts by weight of A1, A2, A3, and A4);
A2 is used in an amount of from 0 to 10 parts by weight based on the sum of the parts by weight of A1, A2, A3, and A4);
A3 is used in an amount of from 0.5 to 25 parts by weight based on the sum of the parts by weight of A1,A2, A3, and A4);
A4 is used in an amount of from 0 to 10 parts by weight based on the sum of the parts by weight of A1,A2, A3, and A4);
A5 is used in an amount of from 0.01 to 5 parts by weight based on the sum of the parts by weight of A1,A2, A3, and A4); and
   wherein said process is carried out at a characteristic number of from 50 to 250.

Another embodiment of the present invention is the above process, wherein B comprises at least one compound selected from the group consisting of 2,4-tolylene-diisocyanate, 2,6-tolylene-diisocyanate, 4,4′-diphenylmethane-diisocyanate, 2,4′-diphenylmethane-diisocyanate, 2,2′-diphenylmethane-diisocyanate, and polyphenyl-polymethylene-polyisocyanate.

Another embodiment of the present invention is the above process, wherein wherein said is carried out at a characteristic number of from 95 to 125.

Another embodiment of the present invention is the above process, wherein said process produces a flexible polyurethane foams having an apparent density of from 10 kg m⁻³ to 200 kg m⁻³.

Another embodiment of the present invention is the above process, wherein A5 comprises a tin(II) salt of a carboxylic acid, wherein said carboxylic acid comprises from 12 to 16 carbon atoms.

Another embodiment of the present invention is the above process, wherein Alb 5 comprises a tin(II) salt of a carboxylic acid having the formula (I)

Sn(CₓH₂ₓ₊₁COO)₂ (I)

wherein
x is an integer from 9 to 15; and
CₓH₂ₓ₊₁ is a branched carbon chain.

Another embodiment of the present invention is the above process, wherein x is an integer from 11 to 15.

Another embodiment of the present invention is the above process, wherein A5 comprises the tin(II) salt of 2-butyloctanoic acid.

Another embodiment of the present invention is the above process, wherein A5 comprises the tin(II) salt of 2-hexyldecanoic acid.

Another embodiment of the present invention is the above process, wherein apart from A5, no further tin(II) salts of carboxylic acids are employed in said process.

Yet another embodiment of the present invention is a polyurethane foam obtained by the above process.

### DESCRIPTION OF THE INVENTION

This object is achieved by a process for the production of polyurethane foams, preferably for the production of flexible polyurethane foams, from
A1 compounds which contain hydrogen atoms which are reactive towards isocyanates and have a molecular weight of 400-15,000,
A2 optionally compounds which contain hydrogen atoms which are reactive towards isocyanates and have a molecular weight of 62-399,
A3 water and/or physical blowing agents,
A4 optionally auxiliary substances and additives, such as
   a) catalysts which differ from component A5,
   b) surface-active additives,
   c) pigments or flameproofing agents,
A5 at least one tin(II) salt of carboxylic acids, the carboxylic acid having from 10 to 16 carbon atoms, and
B di- or polyisocyanates.

The present invention provides in particular a process for the production of polyurethane foams, preferably for the production of flexible polyurethane foams, from

### Component A:

A1 75 to 99.5 parts by wt., preferably 89 to 97.8 parts by wt. (based on the sum of the parts by wt. of components A1 to A4) of compounds which contain hydrogen atoms which are reactive towards isocyanates and have a molecular weight of 400-15,000,
A2 0 to 10 parts by wt., preferably 0 to 2 parts by wt. (based on the sum of the parts by wt. of components A1 to A4) of compounds which contain hydrogen atoms which are reactive towards isocyanates and have a molecular weight of 62-399,
A3 0.5 to 25 parts by wt., preferably 2 to 5 parts by wt. (based on the sum of the parts by wt. of components A1 to A4) of water and/or physical blowing agents,
A4 0 to 10 parts by wt., preferably 0.2 to 4 parts by wt. (based on the sum of the parts by wt. of components A1 to A4) of auxiliary substances and additives, such as
   a) catalysts which differ from component A4,
   b) surface-active additives,
   c) pigments or flameproofing agents,
A5 0.01 -5 parts by wt., preferably 0.05-2 parts by wt., particularly preferably 0.1-1 part by wt. (based on the sum of the parts by wt. of components A1 to A4) of at least one tin(II) salt of carboxylic acids, the carboxylic acid having from 10 to 16 carbon atoms, and

### Component B:

B di- or polyisocyanates,
   wherein the production is carried out at a characteristic number of from 50 to 250, preferably from 70 to 150, particularly preferably from 95 to 125, and wherein all the parts by weight stated for components A1 to A4 in the present application are standardized such that the sum of the parts by weight of components A1+A2+A3+A4 in the composition is 100.

The production of isocyanate-based foams is known per se and described e.g. in DE-A 1 694 142, DE-A 1 694 215 and DE-A 1 720 768 and in Kunststoff-Handbuch volume VII, Polyurethane, edited by Vieweg and Höchtlein, Carl Hanser Verlag Munich 1966, and in the revised edition of this book, edited by G. Oertel, Carl Hanser Verlag Munich, Vienna 1993.

In this context, the foams are predominantly foams containing urethane and/or uretdione and/or urea and/or carbodiimide groups. The use according to the invention preferably takes place in the production of polyurethane and polyisocyanurate foams.

The components described in more detail in the following can be employed for the production of isocyanate-based foams.

### Component A1

Starting components according to component A1 are compounds which have at least two hydrogen atoms which are reactive towards isocyanates and a molecular weight as a rule of 400-15,000. This is understood as meaning, in addition to compounds containing amino groups, thio groups or carboxyl groups, preferably compounds containing hydroxyl groups, in particular compounds containing 2 to 8 hydroxyl groups, specifically those of molecular weight 1,000 to 6,000, preferably 2,000 to 6,000, e.g. polyethers and polyesters as well as polycarbonates and polyester-amides containing at least 2, as a rule 2 to 8, but preferably 2 to 6 hydroxyl groups, such as are known per se for the preparation of homogeneous and of cellular polyurethanes and such as are described e.g. in EP-A 0 007 502, pages 8 - 15. The polyethers containing at least two hydroxyl groups are preferred according to the invention.

### Component A2

Compounds which have at least two hydrogen atoms which are reactive towards isocyanates and a molecular weight of 32 to 399 are optionally employed as component A2. These are to be understood as meaning compounds containing hydroxyl groups and/or amino groups and/or thiol groups and/or carboxyl groups, preferably compounds containing hydroxyl groups and/or amino groups, which serve as chain lengthening agents or crosslinking agents. These compounds as a rule contain 2 to 8, preferably 2 to 4 hydrogen atoms which are reactive towards isocyanates. For example, ethanolamine, diethanolamine, triethanolamine, sorbitol and/or glycerol can be employed as component A2. Further examples of compounds according to component A2 are described in EP-A 0 007 502, pages 16-17.

### Component A3

Water and/or physical blowing agents are employed as component A3. Carbon dioxide and/or highly volatile organic substances as blowing agents are employed, for example, as physical blowing agents.

### Component A4

Auxiliary substances and additives are optionally used as component A4, such as
a) catalysts (activators) which differ from component A5,
b) surface-active additives (surfactants), such as emulsifiers and foam stabilizers, in particular those with low emission, such as, for example, products of the Tegostab® LF series,
c) additives such as reaction retardants (e.g. acidic substances, such as hydrochloric acid or organic acid halides), cell regulators (such as, for example, paraffins or fatty alcohols or dimethylpolysiloxanes), pigments, dyestuffs, flameproofing agents (such as, for example, tricresyl phosphate), stabilizers against the influences of ageing and weathering, plasticizers, fungistatically and bacteriostatically acting substances, fillers, (such as, for example, barium sulfate, kieselguhr, black or prepared chalk) and release agents..

These auxiliary substances and additives which are optionally to be co-used are described, for example, in EP-A 0 000 389, pages 18-21. Further examples of auxiliary substances and additives which are optionally to be co-used according to the invention and details of the mode of use and action of these auxiliary substances and additives are described in Kunststoff-Handbuch, volume VII, edited by G. Oertel, Carl-Hanser-Verlag, Munich, 3rd edition, 1993, e.g. on pages 104-127.

Catalysts which are preferably employed are: aliphatic tertiary amines (for example trimethylamine, tetramethylbutanediamine, 3-dimethylaminopropylamine, N,N-bis(3-dimethylaminopropyl)-N-isopropanolamine), cycloaliphatic tertiary amines (for example 1,4-diaza(2,2,2)bicyclooctane), aliphatic amino ethers (for example bisdimethylaminoethyl ether, 2-(2-dimethylaminoethoxy)ethanol and N,N,N-trimethyl-N-hydroxyethyl-bisaminoethyl ether), cycloaliphatic amino ethers (for example N-ethylmorpholine), aliphatic amidines, cycloaliphatic amidines, urea and derivatives of urea (such as, for example, aminoalkylureas, see, for example, EP-A 0 176 013, in particular (3-dimethylaminopropylamine)-urea).

### Component A5

Tin(II) salts of carboxylic acids are employed as component A5, the particular carboxylic acid on which they are based having from 10 to 16, preferably from 12 to 16 carbon atoms. Preferably, no further tin(II) salts of carboxylic acids are employed in the process according to the invention in addition to component A5.

In a preferred embodiment of the invention, at least one tin(II) salt of the formula (I)

Sn(CₓH₂ₓ₊ᵢ C00)₂ (I)

wherein x denotes an integer from 9 to 15, preferably from 11 to 15, is employed as component A5.

Particularly preferably, in formula (I) the alkyl chain CₓH₂ₓ₊₁ of the carboxylate is a branched carbon chain, i.e. CₓH₂ₓ₊₁ is an iso-alkyl group.

The tin(II) salt of 2-butyloctanoic acid, i.e. tin(II) (2-butyloctoate), and the tin(II) salt of 2-hexyldecanoic acid, i.e. tin(II) (2-hexyldecanoate), are very particularly preferred.

The tin(II) salts according to the invention act as catalysts in the production of polyurethane foam from components A and B. The tin(II) salts according to the invention have the technical advantage over the tin(II) salts known from the prior art that they result, with a good processability, in a polyurethane foam which has low emission values (such as, for example, the VOC value measured by the method VDA 278) and has a good resistance to ageing (such as, for example, compression set).

### Component B

Aliphatic, cycloaliphatic, araliphatic, aromatic and heterocyclic polyisocyanates such as are described e.g. by W. Siefken in Justus Liebigs Annalen der Chemie, 562, pages 75 to 136 are employed as component B, for example those of the formula (II)

Q(NCO)ₙ (II)

in which
n=2-4, preferably 2-3,
and
Q denotes an aliphatic hydrocarbon radical having 2-18, preferably 6-10 C atoms, a cycloaliphatic hydrocarbon radical having 4-15, preferably 6-13 C atoms or an araliphatic hydrocarbon radical having 8-15, preferably 8-13 C atoms.

For example, these are those polyisocyanates such as are described in EP-A 0 007 502, pages 7-8. Particularly preferred compounds are as a rule the polyisocyanates which are readily accessible industrially, e.g. 2,4- and 2,6-toluylene-diisocyanate and any desired mixtures of these isomers (“TDI”); polyphenyl-polymethylene-polyisocyanates, such as are prepared by aniline-formaldehyde condensation and subsequent phosgenation (“crude MDI”) and polyisocyanates containing carbodiimide groups, urethane groups, allophanate groups, isocyanurate groups, urea groups or biuret groups (“modified polyisocyanates”), in particular those modified polyisocyanates which are derived from 2,4- and/or 2,6-toluylene-diisocyanate or from 4,4′- and/or 2,4′-diphenylmethane-diisocyanate. Preferably, at least one compound chosen from the group consisting of 2,4- and 2,6-toluylene-diisocyanate, 4,4′- and 2,4′- and 2,2′-diphenylmethane-diisocyanate and polyphenyl-polymethylene-polyisocyanate (“polynuclear MDI”) is employed as component B.

### Procedure for the Process for the Production of Polyurethane Foams

The polyurethane foams can be produced by various processes of slabstock foam production or in moulds. For carrying out the process according to the invention, the reaction components are reacted by the one-stage process which is known per se, the prepolymer process or the semi-prepolymer process, mechanical equipment such as is described in U.S. Pat. No. 2,764,565 preferably being used. Details of processing equipment which is also possible according to the invention are described in Vieweg and Höchtlen (eds.): Kunststoff-Handbuch, volume VII, Carl-Hanser-Verlag, Munich 1966, p. 121 to 205.

In the production of foam, according to the invention foaming can also be carried out in closed moulds. In this context, the reaction mixture is introduced into a mould. Metal, e.g. aluminium, or plastic, e.g. epoxy resin, is possible as the mould material. The foamable reaction mixture foams in the mould and forms the shaped article. Foam moulding can be carried out in this context such that the moulding has a cell structure on its surface. However, it can also be carried out such that the moulding has a compact skin and a cellular core. According to the invention, in this connection the procedure can be to introduce foamable reaction mixture into the mould in an amount such that the foam formed just fills the mould. However, the procedure can also be to introduce more foamable reaction mixture into the mould than is necessary to fill in the inside of the mould with foam. In the latter case, the production is carried out with so-called “overcharging”; such a procedure is known e.g. from U.S. Pat. No. 3,178,490 and U.S. Pat. No. 3 182 104.

“External release agents” which are known per se, such as silicone oils, are often co-used for foam moulding. However, so-called “internal release agents” can also be used, optionally in a mixture with external release agents, such as emerges, for example, from DE-OS 21 21 670 and DE-OS 23 07 589.

The polyurethane foams are preferably produced by slabstock foaming or by the double conveyor belt process which is known per se (see, for example, “Kunststoffhandbuch”, volume VII, Carl Hanser Verlag, Munich Vienna, 3rd edition 1993, p. 148).

Preferably, the process according to the invention is used for the production of flexible polyurethane foams with an apparent density (also called bulk density) of from 10 kg m⁻³ to 200 kg m⁻³, particularly preferably from 15 kg m⁻³ to 80 kg m⁻³.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

### Component A1:

A1-1 Trifunctional polyether polyol with an OH number of 48 mg of KOH/g, prepared by DMC-catalysed alkoxylation of glycerol with a mixture of propylene oxide and ethylene oxide in the ratio of amounts of 89/11.
A1-2 Trifunctional polyether polyol with an OH number of 56 mg of KOH/g, prepared by DMC-catalysed alkoxylation of glycerol with a mixture of propylene oxide and ethylene oxide in the ratio of amounts of 99/1.
A1-3 Additive VP.PU84WB78 (polyether polyol formulation with an OH number of 136 mg of KOH/g, Bayer MaterialScience AG, Leverkusen Germany).

### Component A3: Water

### Component A4:

A4-1 Bis[(2-dimethylamino)ethyl] ether (70 wt.%) in dipropylene glycol (30 wt.%) (Niax® Catalyst A-1, Momentive Performance Chemicals, Leverkusen, Germany).
A4-2 1,4-Diazabicyclo[2.2.2]octane (33 wt.%) in dipropylene glycol (67 wt.%) (Dabco® 33 LV, Air Products, Hamburg, Germany).
A4-3 Polyether-siloxane-based foam stabilizer Tegostab® BF 2370 (Evonik Goldschmidt GmbH, Germany).
A4-4 Polyether-siloxane-based foam stabilizer Tegostab® B 8232 (Evonik Goldschmidt GmbH, Germany).

### Component A5:

A5-1: Tin(II) salt of 2-butyloctanoic acid.
A5-2: Tin(II) salt of 2-hexyldecanoic acid.
A5-3: Tin(II) salt of 2-ethylhexanoic acid (Addocat® SO, Rheinchemie, Mannheim, Germany).
A5-4: Tin(II) salt of neodecanoic acid.
A5-5 Tin(II) salt of oleic acid.
A5-6 Tin(II) salt of ricinoleic acid (Kosmos® EF, Evonik Goldschmidt GmbH, Germany).
   General instructions for the preparation of Sn(II) salts A5-1, A5-2, A5-4 and A5-5:
   The carboxylic acids employed in each case are:
   For the preparation of A5-1: 2-butyloctanoic acid.
   For the preparation of A5-2: 2-hexyldecanoic acid.
   For the preparation of A5-4: neodecanoic acid.
   For the preparation of A5-5: oleic acid.

36.0 g of a 30% strength solution of sodium methylate in methanol are added dropwise to a solution of 50 ml of anhydrous methanol and 0.2 mol of the particular carboxylic acid, while stirring. After 1 h, 100 ml of anhydrous toluene are added, and a solution of 18.96 g (0.1 mol) of anhydrous SnCl₂ in 25 ml of methanol is added dropwise. After 1 h, the solvent is removed from the reaction mixture under reduced pressure (50 mbar), 100 ml of anhydrous toluene are then added and the mixture is stirred for 5 min. The mixture obtained is then filtered. The solvent is distilled off from the resulting filtrate under reduced pressure (50 mbar), the particular Sn(II) salt being obtained as the residue.

The following Sn(II) salts were prepared and obtained in the yield and quality stated below in accordance with these general instructions:
A5-1: Starting from 40.5 g of 2-butyloctanoic acid, 46.5 g of tin(II) salt of 2-butyloctanoic acid were obtained as a liquid. Analysis: Sn found 23.0%; calc. 22.8%.
A5-2: Starting from 51.4 g of 2-hexyldecanoic acid, 54.9 g of tin(II) salt of 2-hexyldecanoic acid were obtained as a liquid. Analysis: Sn found 18.5%; calc. 18.8%.
A5-4 Starting from 34.4 g of neodecanoic acid, 36 g of tin(II) salt of neodecanoic acid were obtained as a liquid. Analysis: Sn found 25.0%; calc. 25.7%.
A5-5 Starting from 54.4 g of oleic acid, 60 g of tin(II) salt of oleic acid were obtained as a liquid. Analysis: Sn found 18.0%, calc. 17.9%.

### Component B:

B-1: Mixture of 2,4- and 2,6-TDI in the weight ratio 80:20 and with an NCO content of 48 wt.%.
B-2: Mixture of 2,4- and 2,6-TDI in the weight ratio 65:35 and with an NCO content of 48 wt.%.

### Production of the Polyurethane Foams

The starting components are processed in the one-stage process by means of slabstock foaming under the conventional processing conditions for the production of polyurethane foams. Table 1 shows the characteristic number for the processing (the amount of component B to be employed in relation to component A is obtained from this). The characteristic number (isocyanate index) indicates the percentage ratio of the amount of isocyanate actually employed to the stoichiometric, i.e. calculated, amount of isocyanate groups (NCO).

Characteristic number=[(isocyanate amount employed):(calculated isocyanate amount)]×100 (III)

The bulk density was determined in accordance with DIN EN ISO 845.

The compressive strength (CLD 40%) was determined in accordance with DIN EN ISO 3386-1-98 at a deformation of 40%, 4th cycle.

The tensile strength and the elongation at break were determined in accordance with DIN EN ISO 1798.

The compression set (CS 90%) was determined in accordance with DIN EN ISO 1856-2000 at 90% deformation.

The compression set (CS 50%) was determined in accordance with DIN EN 1856-2000 (22 h, 70° C.) at 50% deformation.

The mechanical properties after ageing in a steam autoclave were determined in accordance with DIN EN 1856-2000 (3 days, 3 cycles at 5 h, 120° C.).

The mechanical properties after ageing in hot air were determined in accordance with DIN EN 1856-2000 (7 days, 140° C.).

The relative change in the compressive strength after ageing in a steam autoclave or after ageing in hot air is calculated according to formula (IV):

$$Δ compressive strength = \frac{\begin{matrix}[ compressive strength after ageing ] - \\ [ compressive strength before ageing ]\end{matrix}}{[ compressive strength before ageing ]} \cdot 100 \% \qquad ( IV )$$

The emission values (VOC and FOG) were determined by method VDA 278.

TABLE 1
Flexible polyurethane foams, recipes and properties

| | | | | 3 | 4 |
|---|---|---|---|---|---|
| | | 1 | 2 | (comp.) | (comp.) |
| A1-1 | pt. by wt. | 95.5 | 95.5 | 95.5 | 95.5 |
| A3 | pt. by wt. | 3.42 | 3.42 | 3.42 | 3.42 |
| A4-1 | pt. by wt. | 0.03 | 0.03 | 0.03 | 0.03 |
| A4-2 | pt. by wt. | 0.09 | 0.09 | 0.09 | 0.09 |
| A4-3 | pt. by wt. | 0.96 | 0.96 | 0.96 | 0.96 |
| A5-1 | pt. by wt. | 0.23 | | | |
| A5-2 | pt. by wt. | | 0.23 | | |
| A5-3 | pt. by wt. | | | 0.15 | |
| A5-4 | pt. by wt. | | | | 0.17 |
| B-1 | pt. by wt. | 48.4 | 48.4 | 48.4 | 48.4 |
| Characteristic number | | 115 | 115 | 115 | 115 |
| Properties | | | | | |
| Bulk density | [kg/m³] | 27.6 | 28.3 | 27.1 | 27.4 |
| Compressive strength | [kPa] | 4.03 | 3.67 | 3.82 | 4.61 |
| Tensile strength | [kPa] | 88 | 92 | 93 | 99 |
| Elongation at break | [%] | 123 | 163 | 141 | 137 |
| Compression set | [%] | 6.0 | 5.2 | 5.8 | 11.7 |
| VOC (VDA 278) | [mg/kg] | 16 | 11 | 112 | 146 |
| FOG (VDA 278) | [mg/kg] | 48 | 50 | 34 | 46 |

The catalysts A5-1 (tin(II) salt of 2-butyloctanoic acid) and A5-2 (tin(II) salt of 2-hexyldecanoic acid) according to the invention have the advantage that these are liquid at room temperature and show a good catalytic activity as the catalyst in the production of polyurethane foams. The resulting flexible polyurethane foams (Examples 1 and 2 according to the invention) have good mechanical properties and very low VOC values in the emission test according to VDA 278.

When tin(II) salts known from the prior art are employed as catalysts, in the case of the tin(II) salt of 2-ethylhexanoic acid (component A5-3) unfavourable high VOC values result (Comparison Example 3), and in the case of the tin(II) salt of neodecanoic acid (component A5-4), comparatively high compression set values result.

When the tin(II) salt of oleic acid (component A5-5) is employed as component A5 in the recipes of Table 1, this leads to unusable polyurethane foams because the reaction mixture does not set during the production.

TABLE 2
Flexible polyurethane foams, recipes and properties

| | | | | 7 | 8 | 9 |
|---|---|---|---|---|---|---|
| | | 5 | 6 | (comp.) | (comp.) | (comp.) |
| A1-2 | pt. by wt | 75.26 | 75.26 | 75.26 | 75.21 | 75.21 |
| A1-3 | pt. by wt. | 21.85 | 21.85 | 21.85 | 21.84 | 21.84 |
| A3 | pt. by wt. | 2.14 | 2.14 | 2.14 | 2.14 | 2.14 |
| A4-1 | pt. by wt. | 0.07 | 0.07 | 0.07 | 0.14 | 0.14 |
| A4-4 | pt. by wt. | 0.68 | 0.68 | 0.69 | 0.68 | 0.68 |
| A5-1 | pt. by wt. | 0.34 | | | | |
| A5-2 | pt. by wt. | | 0.34 | | | |
| A5-3 | pt. by wt. | | | 0.16 | | |
| A5-4 | pt. by wt. | | | | 0.19 | |
| A5-6 | pt. by wt. | | | | | 0.34 |
| B-2 | pt. by wt. | 36.7 | 36.7 | 36.7 | 36.7 | 36.7 |
| Characteristic number | | 112 | 112 | 112 | 112 | 112 |
| Properties | | | | | | |
| Bulk density | [kg/m³] | 44 | 44.9 | 50.5 | 42.2 | 40.7 |
| Compressive strength | [kPa] | 5.98 | 5.85 | 6.95 | 5.93 | 5.19 |
| Tensile strength | [kPa] | 117 | 153 | 124 | 96 | 108 |
| Elongation at break | [%] | 128 | 135 | 124 | 117 | 127 |
| CS 50% | [%] | 1.6 | 1.4 | 1.8 | 2.1 | 2.5 |
| CS 90% | [%] | 3.4 | 3.2 | 3.8 | 4.0 | 4.6 |
| Values after ageing in | | | | | | |
| a steam autoclave: | | | | | | |
| Δcompressive strength | [%] | −6.2 | −6.5 | −10.8 | −6.4 | −6.9 |
| Tensile strength | [kPa] | 126 | 117 | 113 | 107 | 77 |
| Elongation at break | [%] | 222 | 191 | 221 | 201 | 189 |
| CS 50% | [%] | 4.2 | 4.4 | 4.2 | 3.7 | 3.5 |
| Values after ageing in | | | | | | |
| hot air: | | | | | | |
| Δcompressive strength | [%] | −8.6 | −4.8 | −2.8 | −17.4 | −18.0 |
| Tensile strength | [kPa] | 174 | 152 | 143 | 125 | 104 |
| Elongation at break | [%] | 140 | 178 | 166 | 182 | 164 |
| CS 50% | [%] | 1.7 | 1.8 | 1.7 | 1.9 | 1.6 |

The results of Table 2 illustrate the mechanical properties also after ageing of the flexible polyurethane foams which were produced with the catalysts A5-1 (tin(II) salt of 2-butyloctanoic acid) and A5-2 (tin(II) salt of 2-hexyldecanoic acid) according to the invention (Examples 5 and 6 according to the invention): It was found, surprisingly, that the polyurethane foams produced with the aid of the tin(II) salts A5-1 and A5-2 according to the invention achieve the level of mechanical values of polyurethane foams produced with the tin(II) salt of 2-ethylhexanoic acid. As shown with the aid of the above in Table 1, however, the polyurethane foams produced with the tin(II) salts according to the invention have the additional advantage that they have significantly lower emission values.

However, when the tin(II) salts A5-4 and A5-6 are employed as catalysts, a comparatively unfavourable level of values results after ageing in a steam autoclave or after ageing in hot air (Comparison Examples 8 and 9).

1. A process for producing a polyurethane foam from
A1 a compound comprising hydrogen atoms reactive towards isocyanate groups and having a molecular weight of from 400 to 15,000;
A2 optionally a compound comprising hydrogen atoms reactive towards isocyanate groups and having a molecular weight of from 62 to 399;
A3 water and/or a physical blowing agent;
A4 optionally at least one auxiliary substance and/or additive;
A5 at least one tin(II) salt of a carboxylic acid, wherein said carboxylic acid comprises from 10 to 16 carbon atoms; and
B a di- or polyisocyanate;
wherein said process comprises reacting A1 and optionally A2 with B in the presence of A3, optionally A4, and A5.

2. The process of claim 1, wherein said at least one auxiliary substance and/or additive is a catalyst different from component A5, a surface active additive, a pigment, and/or a flameproofing agent.

3. The process of claim 1, wherein
A1 is used in an amount of from 75 to 99.5 parts by weight based on the sum of the parts by weight of A1, A2, A3, and A4);
A2 is used in an amount of from 0 to 10 parts by weight based on the sum of the parts by weight of A1, A2, A3, and A4);
A3 is used in an amount of from 0.5 to 25 parts by weight based on the sum of the parts by weight of A1, A2, A3, and A4);
A4 is used in an amount of from 0 to 10 parts by weight based on the sum of the parts by weight of A1, A2, A3, and A4);
A5 is used in an amount of from 0.01 to 5 parts by weight based on the sum of the parts by weight of A1, A2, A3, and A4); and
wherein said process is carried out at a characteristic number of from 50 to 250.

4. The process of claim 1, wherein B comprises at least one compound selected from the group consisting of 2,4-tolylene-diisocyanate, 2,6-tolylene-diisocyanate, 4,4′-ldiphenylmethane-diisocyanate, 2,4′-diphenylmethane-diisocyanate, 2,2′-diphenylmethane-diisocyanate, and polyphenyl-polymethylene-polyisocyanate.

5. The process of claim 1, wherein wherein said is carried out at a characteristic number of from 95 to 125.

6. The process of claim 1, wherein said process produces a flexible polyurethane foams having an apparent density of from 10 kg m⁻³ to 200 kg m⁻³.

7. The process of claim 1, wherein A5 comprises a tin(II) salt of a carboxylic acid, wherein said carboxylic acid comprises from 12 to 16 carbon atoms.

8. The process of claim 1, wherein A5comprises a tin(II) salt of a carboxylic acid having the formula (I)
Sn(CₓH₂ₓ₊₁COO)₂ (I)
wherein
x is an integer from 9 to 15; and
CₓH₂ₓ₊₁ is a branched carbon chain.

9. The process of claim 8, wherein x is an integer from 11 to 15.

10. The process of claim 1, wherein A5 comprises the tin(II) salt of 2-butyloctanoic acid.

11. The process of claim 1, wherein A5 comprises the tin(II) salt of 2-hexyldecanoic acid.

12. The process of claim 1, wherein apart from A5, no further tin(II) salts of carboxylic acids are employed in said process.

13. A polyurethane foam obtained by the process of claim 1.
